(19) United States
(12) Patent Application Publication
(10) Pub. No.: US 2007/0000328 A1
(43) Pub. Date: Jan. 4, 2007

(54) Ultrasonic method for the accurate measurement of crack height in dissimilar metal welds using phased array

(76) Inventor: Jonathan Buttram, Bedford, VA (US)

Correspondence Address: THE TECHNOLOGY LAW OFFICES OF VIRGINIA, P.O. Box 818, Middleburg, VA, 20118, US

(21) Appl. No.: 11/030,365

(22) Filed: Jan. 6, 2005

(51) Int. Cl. G01H 5/00

(52) U.S. Cl. 73/597

(57) ABSTRACT

An ultrasonic method and apparatus utilizing phased array technology for obtaining accurate crack height measurements in materials where crystallographic structure creates beam reduction effects.

### 1.0 FIELD OF INVENTION

This invention relates overall, to the ultrasonic inspection of dissimilar metal welds where ferritic steel is welded to an austenitic material, and, in particular to the use of phased array ultrasonic hardware in conjunction with a theoretical time-of-flight model in accurately determining the through-wall dimension of a crack.

### 2.0 BACKGROUND

Dissimilar metal welds are used throughout nuclear power plants wherever a ferritic component is joined to an austenitic component. For example, the reactor vessels of commercial nuclear power facilities are fabricated from thick-sectioned carbon steel materials and claded for corrosion prevention. In contrast, most piping used to carry coolant water and steam to and from the reactor vessel is fabricated from a stainless steel alloy. Where these two components attach, is a weldment that secures two materials that have different material properties. Differences in material properties such as thermal expansion coefficients, Young's modulus, metallurgical grain size and orientation, hardness, resistance to fatigue failure, etc., make these welds highly susceptible to crack initiation caused by high residual stresses, intergranular stress corrosion cracking, or other mechanisms.

Dissimilar metal welds have long been identified as a difficult component to inspect using conventional ultrasonic techniques (the only applicable method for single surface inspection) due primarily to the anisotropic nature of the weld. The actual inspectability of these welds has not been fully realized until recently when the NRC (Nuclear Regulatory Commission) adopted Appendix VII of Section XI of the ASME code as a requirement for in-service inspection of nuclear facilities. As a result, all vendors that perform inspections on specific safety critical components after Nov. 22, 2002, must have successfully passed a series of blind tests on samples containing real flaws. This performance based criteria are designed to improve flaw detection and sizing capabilities of vendors while preventing inferior techniques from being deployed to sites.

On Jan. 21, 2003, the NRC issued a regulatory issue summary (RIS) 2003-01 titled “Examination of Dissimilar Metal Welds Supplement 10 to Appendix VIII of Section XI of the ASME Code”. In this document it is stated that,
“The NEI (Nuclear Energy Institute) representatives indicated that licensees had not qualified any procedures or personnel to meet the requirements of Supplement 10 (Supplement 10 pertains to DM weld inspection from the OD surface). The NEI further projected that the earliest any qualification could be completed was the end of November or December 2002”.

Although some vendors have been able to successfully satisfy the flaw detection criteria of Appendix VIII Supplement 10, no vender to date has passed the flaw through-wall sizing requirements using manual ultrasonic examination methods. This has become a significant problem for the commercial power utilities as nuclear plants in the United States are commonly 30-40 years old. An increasing number of cracks have been found in dissimilar metal welds over the last 5-10 years in both Pressure Water Reactors and Boiling Water Reactors.

There are cases where the crack has propagated completely through the weld resulting in water leakage before being detected by visual inspection or through the use of leak detection sensors. Currently if a utility discovers a flaw in a dissimilar metal weld, they are forced to perform an automated examination, replace the component or perform an overlay repair. Since access is limited on many DM welds preventing the mounting of automated scanner equipment, a forced-repair scenario can occur.

This invention directly addresses the problem of flaw sizing in DM welds through the use of an approach that is significantly different from current manual techniques proven to be ineffective and was developed to minimize the deleterious effects of DM weld microstructure on sizing accuracies.

The inspection of dissimilar metal welds from the OD has been performed using single or dual element transducers operated in a pulse-echo configuration as illustrated in FIG. 1. In a pulse-echo test, a crack is detected and sized using sound energy that returns along the same general path to the transducer from which it originated. When evaluating the response from a ID surface connected crack, two types of signals are observed: reflections from the crack surface, and diffracted energy originating from the crack tip. While the corner reflection is typically an high amplitude, directional signal, the tip-diffracted signal is commonly very weak and is irradiated omni-directionally from the crack tip. Knowing the angle of sound propagation, θ, and the difference in an arrival time of the two signals the flaw height can be determined either mathematically or directly from an UT instrument that has been accurately calibrated. This technique is the most common ultrasonic method for crack detection and sizing and works quite well on most weld configurations. Unfortunately, the unique properties associated with dissimilar metal welds have rendered this approach unreliable especially for crack height measurements.

A dissimilar metal weld consists of three separate phases; the carbon steel, the stainless steel., and the Inconel used as buttering between the ferritic and austenitic materials. The anisotropic nature of the weld is created by the grain structure (orientation, size and shape) and slight differences in material velocities causing problems at phase boundaries. Ultrasonically the material can significantly alter the angle of propagation of a sound wave.

Beam redirection is one of the primary causes of inaccuracies associated with flaw through-wall sizing in dissimilar metal welds. Columnar grain structure associated with cast austenitic materials (weld material) is thought to influence high frequency sound waves by effectively bending or changing the angle at which the wave propagates as illustrated by FIG. 2. In such case, the operator has no knowledge of the change of the beam angle, thus plotting the flaw tip at a depth that is significantly different from its actual location. Beam redirection can result in a large crack being Undersized, or a small crack being oversize. In either case, the consequences are potentially very costly.

Accurate through-wall sizing is dependant upon the detection and location of the tip-diffracted signal. Location of this signal is performed by knowing the angle of propagation relative to the component surface plane, and the distance traveled by the sound wave calculated from the time-of-flight and material velocity. Depth is determined through simple trigometric relationships. When the angle of propagation is inadvertently changed without knowledge of the operator, the measured depths of cracks will be in error.

### 3.0 SUMMARY OF INVENTION

The inspection method is based on phased array ultrasonic technology. Ultrasonic phased array systems use transducers that have many small piezoelectric crystals or elements, that are fired independently of each other. The firing sequence and relative time delays are determined by focal laws, or calculated firing delay times that are entered into the instrument. These calculated firing sequences determine the angle of propagation of the wave front as well as beam focusing characteristics. Phased array systems are unique in that a transducer can produce sound waves that sweep through a range of angles without any mechanical adjustments or movement to the transducer.

FIGS. 3 & 4 are illustrations of two transducer arrangements that can be used for this invention. The transducer arrangement is comprised of two separate transducer housings (transmit and receive), each containing one array (an array consists of multiple piezoelectric elements). The transmit array is configured to operate where elements are activated to produce a swept beam as illustrated in FIGS. 3 and 4. Note that in both cases the transmit beam is focused along a defined linear zone that extends from the ID surface to the OD surface. Similarly, the receiver array is also configured so that its focal laws force it to focus along the same linear focal zone extending from the ID surface to the OD surface. During the operation of the phased array system, the receiver and transmitter operate together resulting in a focal spot that is swept continuously up and down the defined linear focal zone. The ability to electronically focus both transducer arrays significantly improves the sensitivity of the inspection to weak tip diffracted signals that originate from crack tips residing in the focal zone. Crack tips that are located in material outside the focal zone are not detected since the beams are largely defocused in these regions. A key aspect of this invention is to use a transducer arrangement that is sensitive primarily to tip diffracted signals (less sensitive to reflected energy) that originate from a defined position in space for each angle of wave propagation.

The transducer assembly shown in FIG. 5, is designed so that the distance separating the transmitter and receiver transducers can be adjusted and then secured. The separation distance is adjusted depending upon the thickness of the material to be tested., the transducer wedge angle and weld geometry. Commonly the transducer arrays are coupled to wedges (typically fabricated from Plexiglas or similar material) which allow for more efficient transmission and reception of sound energy at high beam angles as well as permit contouring of the transducer contact surface without damaging the transducer array.

A second component critical to this invention is the use of what is referenced as a time-of-flight simulator or model. The simulator is a computer model that replicates the conditions found during the inspection, and calculates the theoretical time-of-flight of the sound wave for a given angle of propagation. Model inputs include transducer separation, wedge dimensions, wedge velocity, test material velocity, inspection surface geometry, material thickness, model time delay and beam redirection angle as illustrated in FIG. 6. The model first calculates the time-of-flight of the sound wave through both the wedge and weld materials using the beam diffraction relations defined by Snell's Law. Snell's law defines the beam angle change due to refraction as the sound wave transitions the wedge/steel interface as follows:
sin(θWedge)/sin(θSteel)=Wedge Velocity/Steel Velocity

The model is also capable of recalculating time-of-flight values based on varying degrees of beam redirection as created by the effects of columnar crystallographic structure commonly found in dissimilar metal welds. The model simulates redirection effects by calculating time-of-flight values associated with beam angle changes in the weld material only as a result of crystallographic effects.

The use of the simulator allows the operator to compare the measured travel time of tip diffracted signals that are detected at a specific angle of propagation to that calculated. For example, if a tip diffracted signal is detected at a 55°, the time it takes for the sound to travel to the crack tip and back is calculable knowing sound velocities and geometric conditions. If the operator measures a time-of-flight that that is different from that calculated for the 55° angle of propagation then beam redirection must be occurring. The model is then adjusted with different beam redirection angles until the arrival time of the signal matches that calculated by the model. At this point the model has determined the angle of propagation plus beam redirection angle. With all beam path angles fully characterized, the model is capable of calculating an accurate crack tip depth.

This technique requires the use of a calibration block similar to the shown in FIG. 7. This block must be fabricated from the same material being inspected, must be identical to the surface geometry of the component to the inspected, and must contain at least one machined reflector (notch or side drilled hole) that is located at a defined depth. The calibration block is used to adjust model and instrument parameters so that the calculated time-of-flight of the reflector calculated by the model matches the time-of-flight measured by the phased array system. This block is used prior to the collection of data to assure that simulator results are accurate.

The invention is designed to be used in industrial conditions. Once calibrated, the operator can locate all hardware adjacent to the flaw location. Data is collected by scanning the transducer assembly across the flaw location. Scanning motion can vary as long as the position of the linear focal zone intersects with the crack position at various positions along the flaw. The display of the phased array system should be used during data collection to assure that tip signals associated with the position of maximum depth are collected. If the flaw position is not clearly defined or a diffraction map of the area is wanted, then the system can be used in combination with a 2-axis scanner to produce an encoded image.

### 4.0 BRIEF DESCRIPTION OF DRAWINGS

FIG. 1 illustrates the pulse-echo inspection configuration that has been proven to be ineffective for providing accurate crack height measurements in dissimilar metal welds.

FIG. 2 illustrates the effects of columnar grain structure in weld material on the ultrasonic beam, resulting in beam redirection and inaccurate crack height measurements.

FIG. 3 illustrates a pitch-catch configuration where receiver is located directly above the focal zone. This configuration requires flush weld crowns.

FIG. 4 illustrates a pitch-catch configuration where the receiver is located on the opposite side of the focal zone. This configuration does not require that weld crowns be flush.

FIG. 5 is a basic layout of major system components including (a) transducer assembly, (b) ultrasonic phased array system, and (c) model used for simulating beam path and time-of-flight measurements.

FIG. 6 indicates model input and output parameters for pitch-catch transducer configuration on flat plate.

FIG. 7 illustrates a typical calibration block used to adjust model parameters so that it simulates the ultrasonic results with accuracy. Calibration block must have at least one reflector (side drilled hole) located at a specific depth and fabricated from the same material as that inspected.

FIG. 8 is an example of a geometry corrected sector scan image produced by phased array system. Sector scan is a plot of signal time-of-flight verses propagation angle. Color indicates signal amplitude.

FIG. 9 illustrates the logic behind the redirection model where the redirection angle (ζ) is added to the angle of propagation (θ2) until the time-of-flight of the signal matches that calculated by the model for the given angle of propagation. Note that the sound path distance in the wedge does not change with the introduction of a redirection angle.

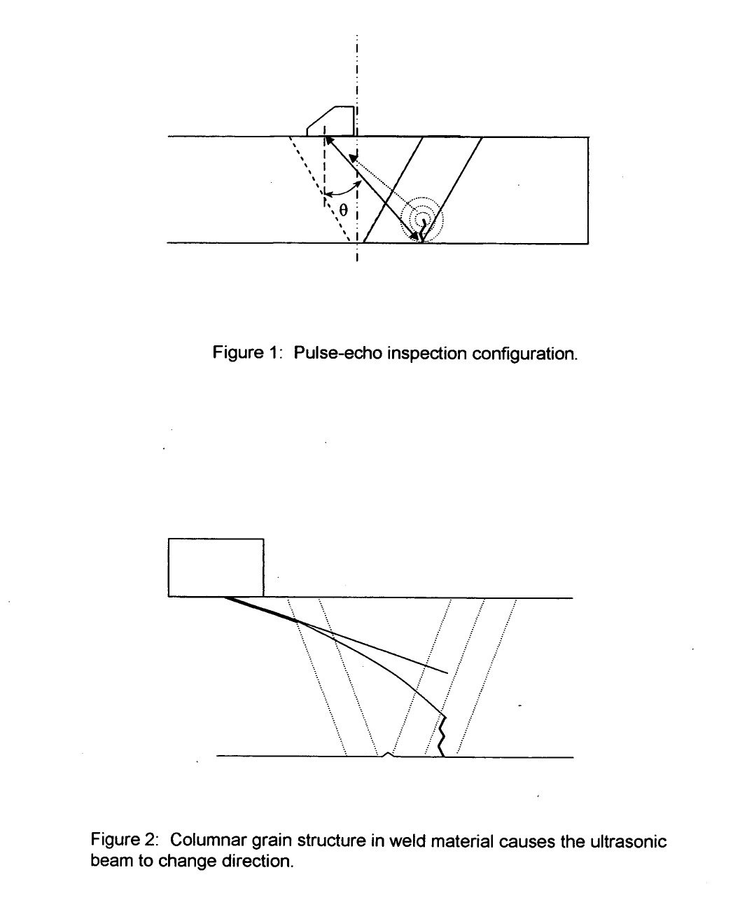

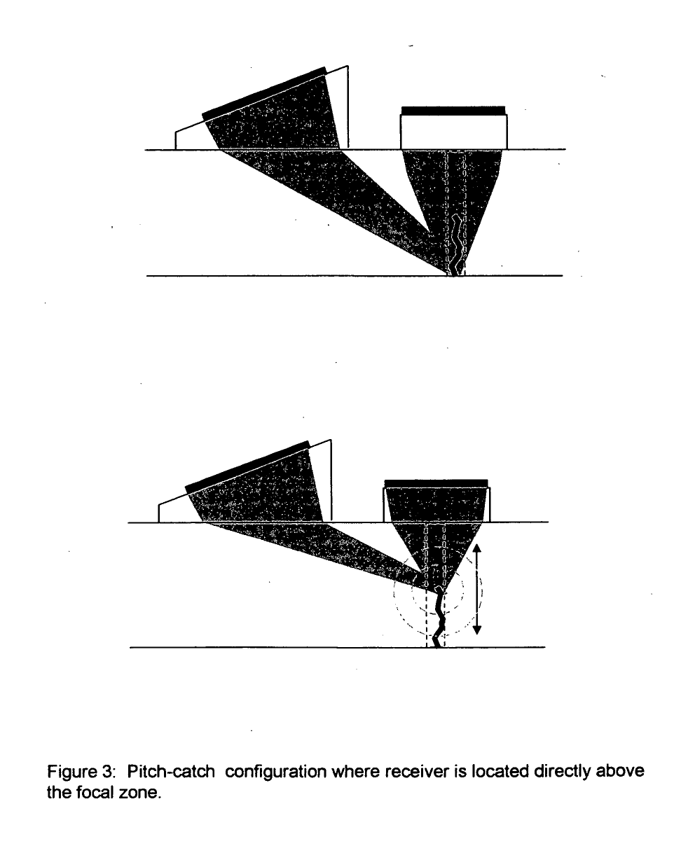

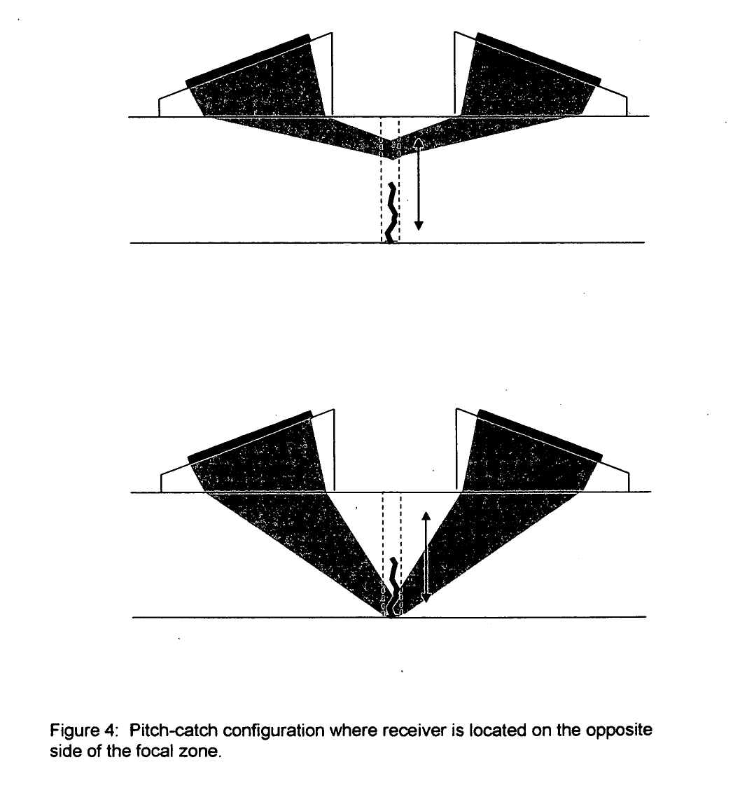

### 5.0 DESCRIPTION OF INVENTION

The present invention is an ultrasonic inspection technique used for the measurement of crack tip depth in large grain materials where crystallographic structure results in beam redirection or bending.

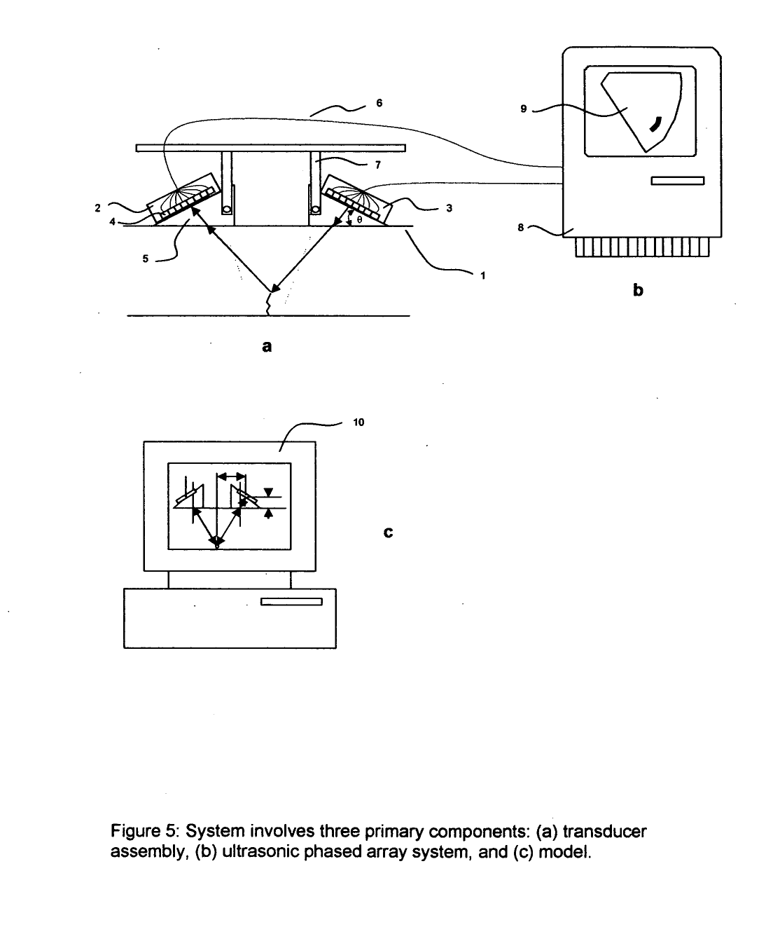

FIG. 5 is an illustration of the transducer assembly mounted on the OD surface 1 of a circumferntial pipe weld. The transducer assembly consists of two separate ultrasonic transducers 2 & 3. One transducer acts as a ultrasonic transmitter 3, and the second transducer 2, as the receiver.

Each transducer housing 2 & 3, consists of an array of piezoelectric crystals 4, mounted to a wedge 5, where a sound coupling medium is applied between the two components. The array 4, consists of numerous individual piezoelectric crystals (typically between 8-16 crystals). Each crystal is electrically connected to either a transmitter or receiver channel on the ultrasonic phased array system using a shielded cable 6.

The ultrasonic energy is produced by applying a voltage across each piezoelectric crystal 4, which produces small displacements that are transferred to the wedge 5, and then into the pipe material 1. The reverse of this process defines the operation of the receiver transducer.

Each transducer array is mechanically attached to wedge 5. The wedge is designed to a specific angle (θ), depending on the thickness of the component inspected. A properly selected wedge angle (θ) will result in improved efficiently of the inspection by increasing the signal-to-noise of the tip diffracted signals. The use of a wedge 5, allows for a cost effective method of contouring the transducer surface when inspecting curved surfaces without modifying the ultrasonic transducer 2 & 3.

Each transducer is attached to a mechanical apparatus 7 that allows for adjustment in the separation between the transmitter and receiver transducers 2 & 3. The apparatus also allows for small gimbling so that the transducer can seat fully to the surface. Once adjusted, the apparatus 7, can be locked so that the distance between the transmitter and receiver transducers remains at a constant separation distance.

The transducer assembly is connected to the ultrasonic phased array system with multi-conductor shielded co-axial cable 6, used for conducting electrical signals to and from each individual array crystal 4.

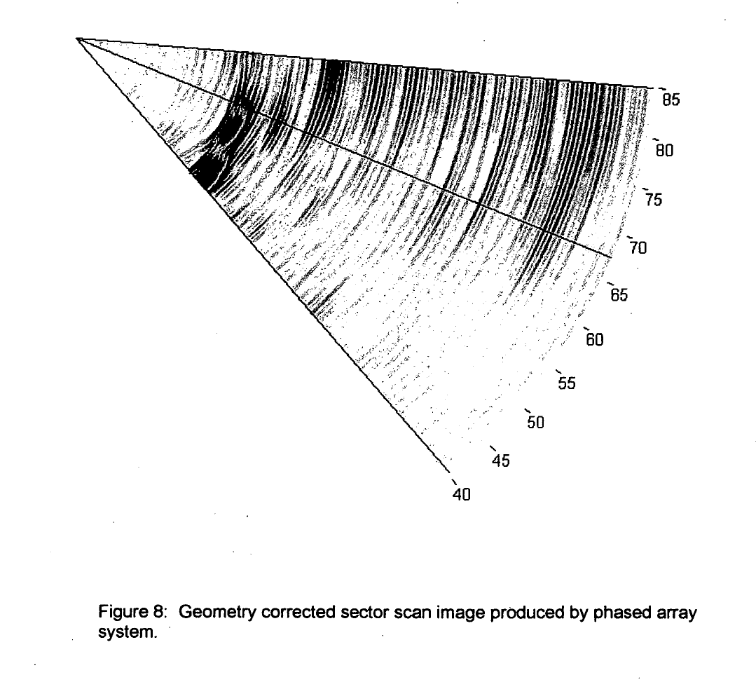

The ultrasonic phased array system 8, is a portable multi-channel system capable of supporting two separate transducer arrays operated in a pitch-catch configuration. The phased array system shall be capable of displaying a sector scan 9 (also FIG. 8) where the angle of propagation (transmitter) is plotted against the absolute time-of-flight of a signal. FIG. 8 is an example of a geometry corrected sector scan.

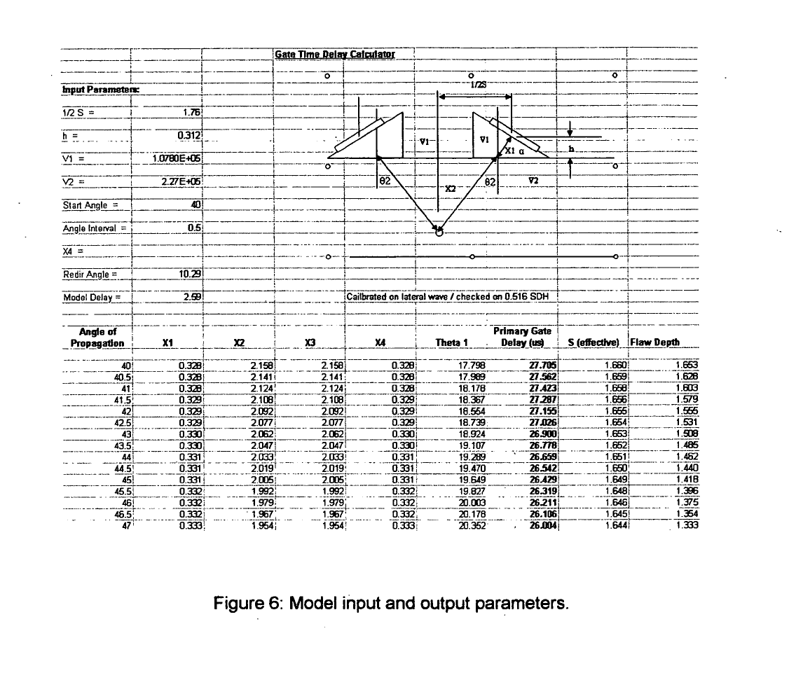

Separate from the phased array system 9, is a computer based time-of-flight simulator 10. FIG. 6 shows the input and output parameters for this model. The model calculates the expended time-of-flight and depth for each angle of propagation. The model is designed to compensate for beam bending if it is determined to be occurring, thus allowing for accurate flaw height measurements.

The methodology used when performing this invention technique is as follows:

The Phased array system parameters (focal laws) are adjusted to produce angles of propagation that sweep over a range that assure that the full thickness of the component being inspected is displayed in the Sector Scan image. Focal laws should also force beam focusing along a linear focal zone extending from the ID to the OD surface.

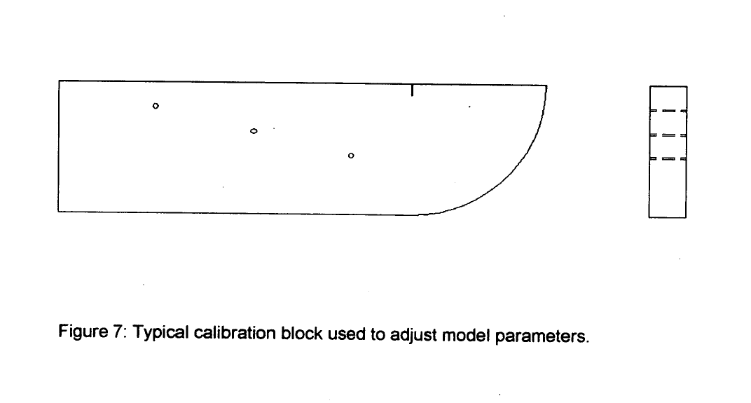

The transducer assembly is placed on a calibration block similar to that shown in FIG. 7. The calibration reflector signal is peaked on the sector scan image and its propagation angle and time-of-flight measured.

Parameters related specifically to the test configuration and transducer Setup in entered in the computer model. The measured beam angle and time-of-flight values are compared to the values calculated by the computer based model for a reflector at this depth. The “wedge velocity” value on the phased array system is adjusted until the angle of propagation of the calibration reflector corresponds to that of the computer based model. The “time delay correction” value on the computer based model is adjusted until the time-of-flight calculated by the model is equivalent to that measured on the phased array system. This procedure assures that the computer based model is a good simulation for the transducer assembly.

The transducer is scanned in a raster pattern across the area where the crack exists. The sector scan image is observed for the presence of a tip diffracted signal.

Once the tip diffracted signal is observed, its angle of propagation and time-o-f-flight are measured.

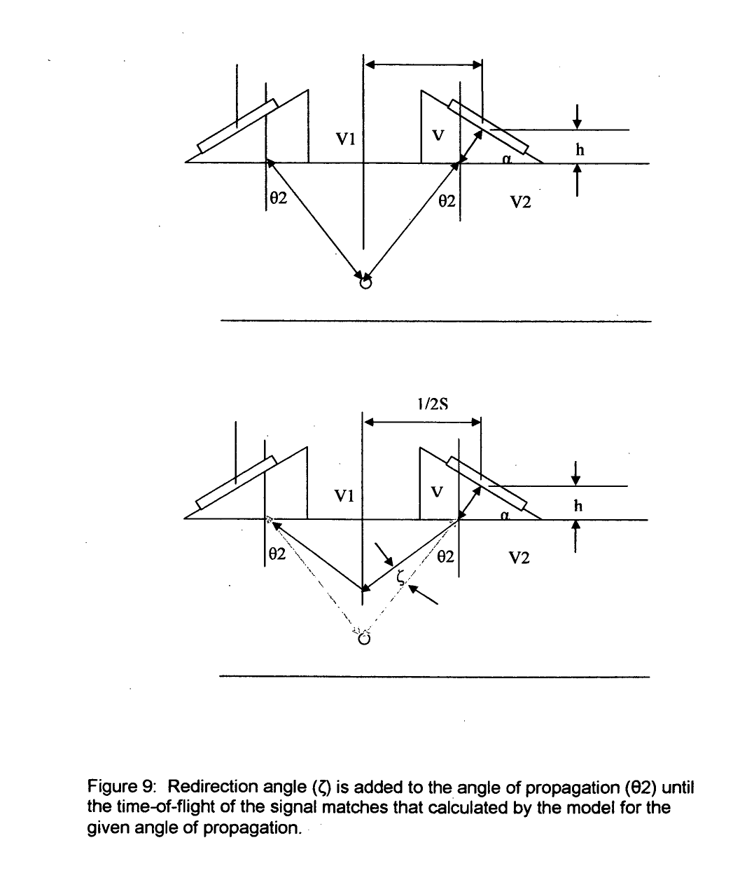

The measured angle and time-of-flight are compared to that calculated by the model. If the time-of-flight value is different from that calculated by the model for the measured angle, “redirection angle” is added to the model. The addition of redirection angle effectively increases the theoretical beam angle without any modification to the sound beam angle in the wedge material FIG. 9 illustrates this change.

Once the proper redirection angle is added to the model so that the time-of-flight value is equivalent to that measured for the beam angle, the depth of the flaw tip can be obtained from the model.

What is claimed is:

1. A method for measuring the through-wall dimension of a crack using an ultrasonic phased array system and time-of-flight simulation software, the method comprising the steps of:
providing first and second phased array transducers arranged in pitch-catch mode on opposite sides of the crack at a selected location corresponding to the focal zone of the transducer pair;
propagating focused sound waves from the transmitter transducer through a range of angles so that when combined with the corresponding range of focus locations generated by the receiver transducer, a focal zone is created from one side of the component, through the thickness, to the inspection surface,
receiving the tip diffracted signal originating from the crack tip
measuring the angle of propagation and absolute time-of-flight of the maximized tip diffracted signal
comparing the measured time-of-flight value with the theoretical time-of-flight value calculated for the measured angle of propagation according to the relationship
time-of-flight=(Wedge 1 Distance)/(Wedge 1 Velocity)+(Wedge 2 Distance)/(Wedge 2 Velocity)+Material Distance/Material Velocity
modifying the theoretical time-of-flight value by simulating beam redirection angles until it equals the measured time-of-flight value for the measured angle of propagation
determining flaw height through trigonometric relationships using the beam redirection angle in addition to the measured angle of propagation.

2. A method according to claim 1, wherein the transducer can propagate either shear or longitudinal wave modes.

3. A method according to claim 1, wherein the transducer is moved along the surface either manually or through motorized means in order to locate the location on the crack of maximum height.

4. A method according to claim 1, wherein the sector scan display produced by the phased array system is used for tip signal recognition.

5. A method according to claim 1, wherein the transducer arrangement can be changed so that the receiver is positioned directly over the crack location or adjacent to the transmitting transducer.

6. A method according to claim 1, wherein the transducer can propagate either shear or longitudinal wave modes.

7. A method according to claim 1, wherein the transducers used can be used with or without transducer wedges.

8. A method according to claim 1, wherein the transducers are mechanically held by an apparatus where the distance separating the transmitter and receiver is adjustable.

9. A method according to claim 1, wherein phased array system is portable.

10. A method according to claim 1, wherein the data can be stored and analyzed away from the inspection location.
